(19) United States
(12) Patent Application Publication
(10) Pub. No.: US 2026/0046591 A1
(43) Pub. Date: Feb. 12, 2026

(54) SERVICE MANAGEMENT AND ORCHESTRATION (SMO) CONFIGURATIONS FOR EXTERNAL FUNCTIONALITIES

(71) Applicant: QUALCOMM Incorporated, San Diego, CA (US)

(72) Inventors: Satashu Goel, San Diego, CA (US); Geetha Priya Rajendran, Bangalore (IN); Aziz Gholmieh, Del Mar, CA (US); Gavin Bernard Horn, La Jolla, CA (US)

(21) Appl. No.: 18/797,705

(22) Filed: Aug. 8, 2024

(51) Int. Cl. H04W 4/50; H04L 41/0806; H04L 41/16; H04L 41/5051

(52) U.S. Cl. CPC H04W 4/50; H04L 41/0806; H04L 41/16; H04L 41/5051

(57) ABSTRACT

Service management and orchestration (SMO) configurations for external functionalities are disclosed. A network node configured to operate as an SMO framework includes at least one processor. The at least one processor configures the SMO framework to perform operations comprising: receiving, by a Service Management and Orchestration (SMO) framework from a first entity, a first request relating to use of an external application; transmitting, by the SMO framework to a second entity, a second request relating to performance of the external application; receiving, by the SMO framework from the second entity, an indication of a result of the external application; and transmitting an instruction for wireless communication based on the indication. Other aspects and features are also claimed and described.

### TECHNICAL FIELD

This disclosure generally relates to wireless communication systems and, more particularly, to techniques to configure service management and orchestration (SMO) for external functionalities.

### DESCRIPTION OF RELATED TECHNOLOGY

Wireless communications systems are widely deployed to provide various types of communication content such as voice, video, packet data, messaging, broadcast, and so on. A wireless multiple-access communications system may include a number of network nodes, base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, fifth generation (5G) systems which may be referred to as New Radio (NR) systems, and sixth generation (6G) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). To save network energy or use other services, the systems may include predefined components.

As the demand for mobile broadband access continues to increase, the complexity of network operations increases. Research and development continue to advance wireless communication technologies to automatically manage the network operations. A service management and orchestration (SMO) framework is an automation platform. However, due to the continued wireless communication technology advancement, it is in need to flexibly configure the SMO framework for existing and external functionalities.

### SUMMARY OF DISCLOSURE

The following summarizes some aspects of this disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure provides methods, apparatuses, and computer-readable media that support service management and orchestration (SMO) configurations for external functionalities.

In one aspect, a method for wireless communication includes: receiving, by an SMO framework from a first entity, a first request relating to use of an external application; transmitting, by the SMO framework to a second entity, a second request relating to performance of the external application; receiving, by the SMO framework from the second entity, an indication of a result corresponding to the second request transmitted to the second entity; and transmitting an instruction for wireless communication based on the indication.

In another aspect, an apparatus configured to operate as an SMO framework, the apparatus comprising: at least one processor to configure the SMO framework to perform operations comprising: receiving, by the SMO framework from a first entity, a first request relating to use of an external application; transmitting, by the SMO framework to a second entity, a second request relating to performance of the external application; receiving, by the SMO framework from the second entity, an indication of a result corresponding to the second request transmitted to the second entity; and transmitting an instruction for wireless communication based on the indication.

In a further aspect, a computer-readable storage medium that stores instructions for execution by one or more processors of a Service Management and Orchestration (SMO) framework, the instructions to configure the SMO framework to perform operations comprising: receiving, by the SMO framework from a first entity, a first request relating to use of an external application; transmitting, by the SMO framework to a second entity, a second request relating to performance of the external application; receiving, by the SMO framework from the second entity, an indication of a result corresponding to the second request transmitted to the second entity; and transmitting an instruction for wireless communication based on the indication.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of this disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF SUMMARY OF THE FIGURES

The accompanying figures are incorporated into and form a part of the specification to illustrate several examples of this disclosure. These figures, together with the description, explain the principles of the disclosure. The figures simply illustrate preferred and alternative examples of how the disclosure can be made and used and are not to be construed as limiting the disclosure to only the illustrated and described examples. Further features and advantages will become apparent from the following, more detailed, description of the various aspects, examples, and embodiments of the disclosure, as illustrated by the figures referenced below.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 illustrates an example of a wireless communications system that supports service management and orchestration (SMO) configurations for external functionalities in accordance with aspects of this disclosure.

FIG. 5 illustrates a block diagram showing an SMO framework communicating with a foundational service component and a network function according to aspects of this disclosure.

FIG. 6 illustrates a block diagram showing an SMO framework to communicate with network functions according to aspects of this disclosure.

FIGS. 7A-7D show different deployment options of an SMO framework according to aspects of this disclosure. FIG. 7A is a block diagram to show time-scale-based SMO framework deployment. FIG. 7B is a block diagram to show domain-based SMO framework deployment. FIG. 7C is a block diagram to show cell group-based SMO framework deployment. FIG. 7D is a block diagram to show capability-based SMO framework deployment.

FIG. 8 is a block diagram to show SMO framework deployment in a distributed network according to aspects of this disclosure.

FIG. 9 is a sequence diagram to show an onboarding process of an AI/ML foundational service to integrate the foundational service to an SMO framework according to aspects of this disclosure.

FIG. 10 is a sequence diagram to show integration of a foundational service to an SMO framework according to aspects of this disclosure.

FIG. 11 is a sequence diagram to show integration of a foundational service to an SMO framework according to aspects of this disclosure.

FIG. 12 is a sequence diagram to show integration of a foundational service to an SMO framework according to aspects of this disclosure.

FIG. 13 is a block diagram of an example network node that SMO framework configuration for external functionalities according to one or more aspects.

FIG. 14 illustrates a method for wireless communication at a network node according to aspects of this disclosure.

Reference is made to the figures wherein like numerals refer to like parts throughout. The figures are not necessarily to scale, and the skilled artisan will appreciate that certain feature(s) may be exaggerated for clarity, dimensioning, and ease of understanding.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

As the demand for mobile broadband access continues to increase, the complexity of network operations increases. Research and development continue to advance wireless communication technologies to automatically manage the network operations. The SMO framework is an automation platform to maximize the network’s operational efficiency. At the same time, due to the continued wireless communication technology advancement, it is in need to flexibly configure the SMO framework for existing and external functionalities provided by production grade software frameworks.

This disclosure addresses the need for service management and orchestration (SMO) configurations for and integration with external functionalities to collect data and update control policy or commands for wireless communications. In doing so, this disclosure provides a system or method to configure an SMO framework to operate between third-party foundational services and services within the SMO framework and orchestrate different foundational services by providing an integrated interface to the SMO framework. In addition, this disclosure provides different SMO configurations to serve different scopes and/or time scales. This ensures automatic and reliable wireless communications.

One aspect of this disclosure involves an apparatus configured to operate as an SMO framework. The SMO framework interworks with foundational services providing external functionalities as part of the SMO framework, supports interworking between the foundational services and services within the SMO framework, and/or orchestrates different foundational services by providing an integrated interface to the SMO framework. In addition, this disclosure provides different SMO configurations to serve different scopes (e.g., different domains (radio access network (RAN) or core network (CN)), different time scales (e.g., non-real time and/or near-real time)). For example, the SMO framework receives a first request relating to use of an external application (e.g., an artificial intelligence or machine learning (AI/ML) model) from a first entity (e.g., an rAPP in the SMO framework) and transmits a second request relating to performance of the external application to a second entity (e.g., a third-party foundational service component). Then the SMO framework receives, from the second entity, an indication of a result corresponding to the second request transmitted to the second entity and transmits an instruction (e.g., an instruction to enable a network function (NF) to control the wireless communications) for wireless communication based on the indication.

Particular aspects of the subject matter described in this disclosure can be implemented to realize one or more of the following potential advantages. First, a single SMO framework can be configured to provide different functionalities without replicating existing functionalities in the SMO framework. Second, the SMO framework may not consume unnecessary memory space by not storing existing functionalities in the SMO framework. Rather, the SMO framework reduces the processing power by distributing the processing burden to a third-party entity. By providing a flexible SMO framework to use third party foundational services, a range of network management applications with different reliability and latency requirements can be supported. Also, the single SMO framework merging capabilities for non-real time and near-real time control of the network enables efficient and improved management of the functionalities of non-real time and near-real time control applications.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

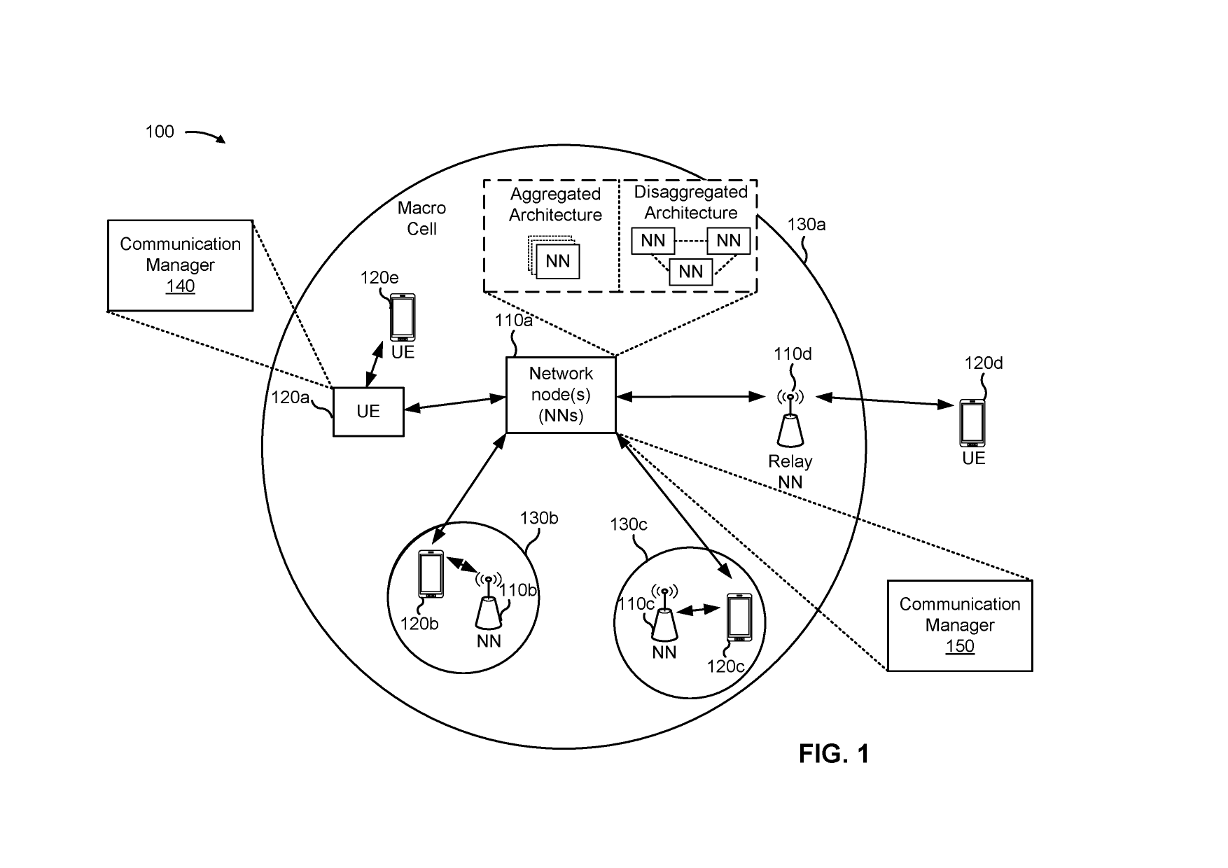

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may obtain an indication that a model, associated with at least one of encoding or decoding, is to be used in association with a control channel; output, after obtaining the indication, one or more model parameters associated with a data distribution of the control channel; encode, using an encoder, data, the encoder being associated with the one or more model parameters; and output the data for transmission via the control channel. Additionally, or alternatively, the communication manager 140 may perform one or more other operations described herein.

In some aspects, the network node 110 may include a communication manager 150. As described in more detail elsewhere herein, the communication manager 150 may output an indication that a model, associated with at least one of encoding or decoding, is to be used in association with a control channel; obtain, after obtaining the indication that the model is to be used, one or more model parameters associated with a data distribution of the control channel; obtain data associated with the control channel; and decode, using at least one of a decoder or an encoder, the data, the decoder and the encoder being associated with the one or more model parameters. Additionally, or alternatively, the communication manager 150 may perform one or more other operations described herein.

As indicated above, FIG. 1 is provided as an example. Other examples may differ from what is described with regard to FIG. 1.

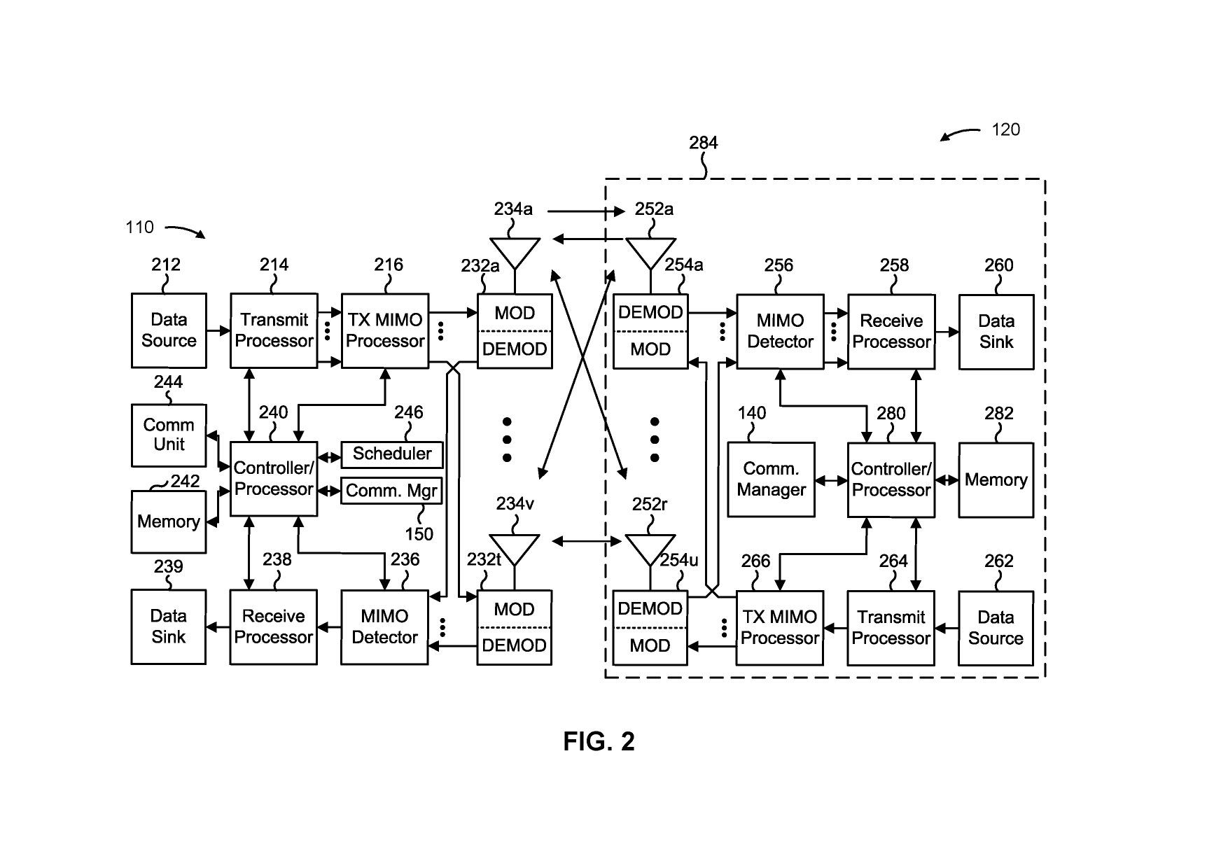

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t ≥ 1), a set of antennas 234 (shown as 234a through 234v, where v ≥ 1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding scheme (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r ≥ 1), a set of modems 254 (shown as modems 254a through 254u, where u ≥ 1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

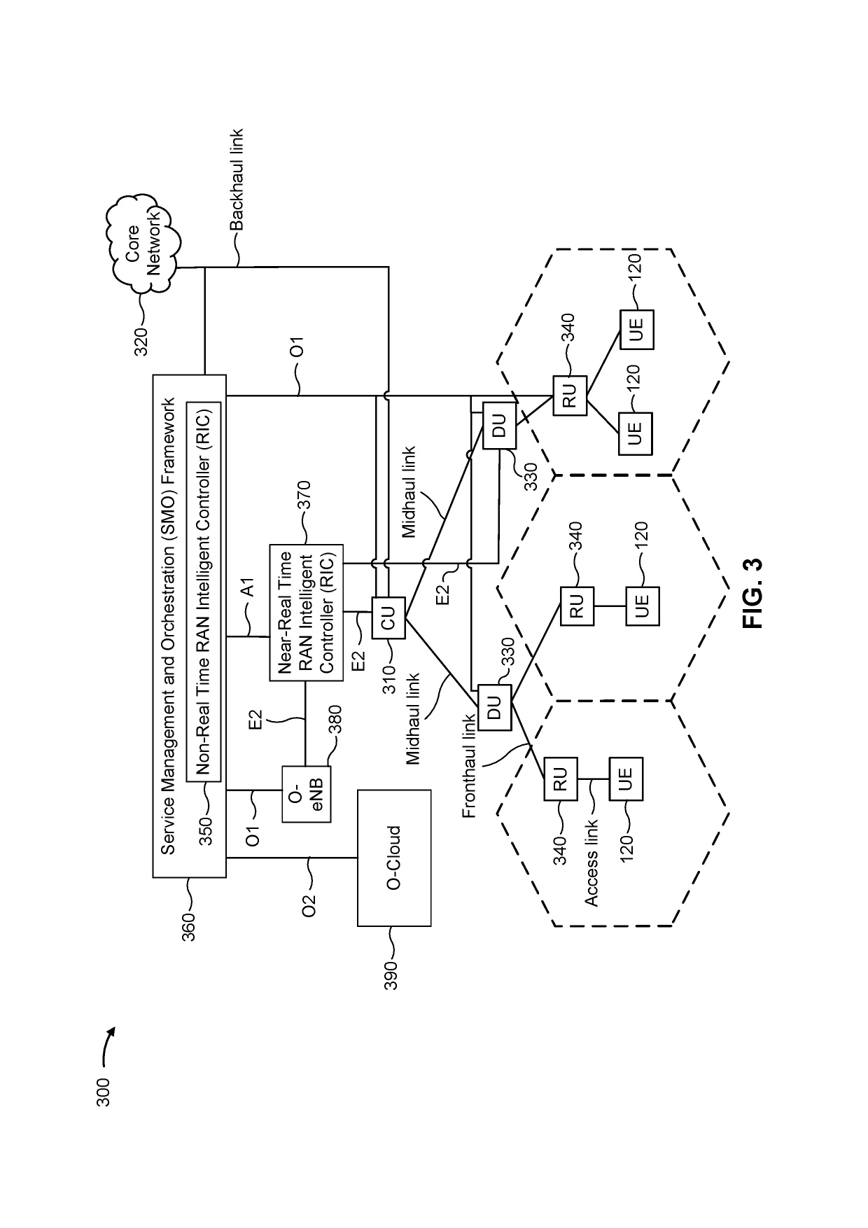

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some examples, for RAN, the Non-RT RIC 350 may be designed to process a task in non-real time (e.g., more than 1 second control loop) while the Near-RT RIC 370 may be designed to process a task in near-real time (e.g., less than 10 millisecond control loop). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330. In some examples, in O-RAN architecture, CU, DU and RU may have equivalent RAN nodes (e.g., O-CU, O-DU and O-RU). Also, O1 and E2 interfaces may be supported by O-RAN nodes and/or 3GPP defined nodes (e.g., CU and DU).

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture. In some examples, the O1 interface may be communicatively coupled to O-RAN NFs (e.g., the CU(s) 310 and DU(s) 330).

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

In other aspects, the SMO framework 360 may include both of the Non-RT RIC 350 and the Near-RT RIC 370. In such examples, the SMO framework 360 may have the same input and output interfaces or different input and output interfaces for the Non-RT RIC 350 and the Near-RT RIC 370. For example, an application (e.g., an energy saving application, a traffic steering application) may process tasks for the near-real time scale and the non-real time scale. When the SMO framework 360 includes the Non-RT RIC 350 and the Near-RT RIC 370, the application does not need to have additional logic or circuit to coordinate two different RICs. In such examples, the SMO framework 360 may include a single RIC or multiple RICs to operate as the Non-RT RIC 350 and the Near-RT RIC 370. In some examples, the SMO framework 360 may directly access the Near-RT RIC 370 and coordinate with the Non-RT RIC 350 and the Near-RT RIC 370. For example, the SMO framework 360 may share policies that the Non-RT RIC 350 and the Near-RT RIC 370 enforce. In further examples, the SMO framework 360 may reuse functionality for the Non-RT RIC 350 and the Near-RT RIC 370 because some functionality is duplicate across the Non-RT RIC 350 and the Near-RT RIC 370 (e.g., application management, service discovery, data discovery, data management, data collection from RAN). In some examples, the applications in SMO framework 360 may interwork with applications in Near-RT RIC without any dependence on A1 interface as the application may discover and communicate with each other without a special interface. In the converged SMO framework to merge functionalities of both the time scales (e.g., non-real time and near-real time), a specific SMO framework may be configured with specific capabilities during deployment. For example, some SMO frameworks may be configured to only have Non-RT control, only have Near-RT control, or have both of Non-RT control and Near-RT control.

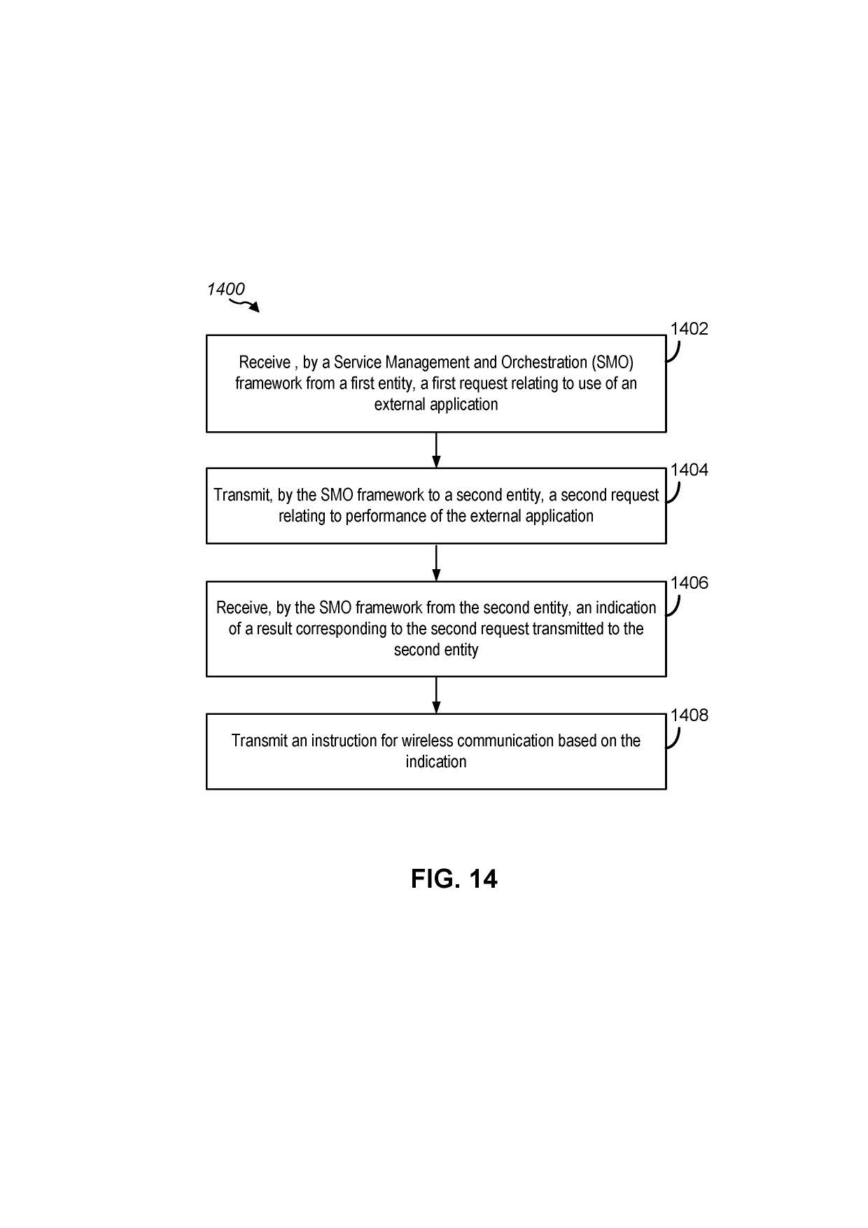

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with model management for control channel encoding or decoding, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1400 of FIG. 14, or other processes as described herein (alone or in conjunction with one or more other processors). In some aspects, the wireless node described herein is the network node 110, is included in the network node 110, and/or includes one or more components of the network node 110 shown in FIG. 2. Additionally, or alternatively, the wireless node described herein is the UE 120, is included in the UE 120, and/or includes one or more components of the UE 120 shown in FIG. 2. For example, as used herein, “wireless node” refers to the network node 110 and/or the UE 120.

The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1400 of FIG. 14, or other processes as described herein. In some examples, executing instructions may include running the instructions, converting the instructions, compiling the instructions, and/or interpreting the instructions, among other examples.

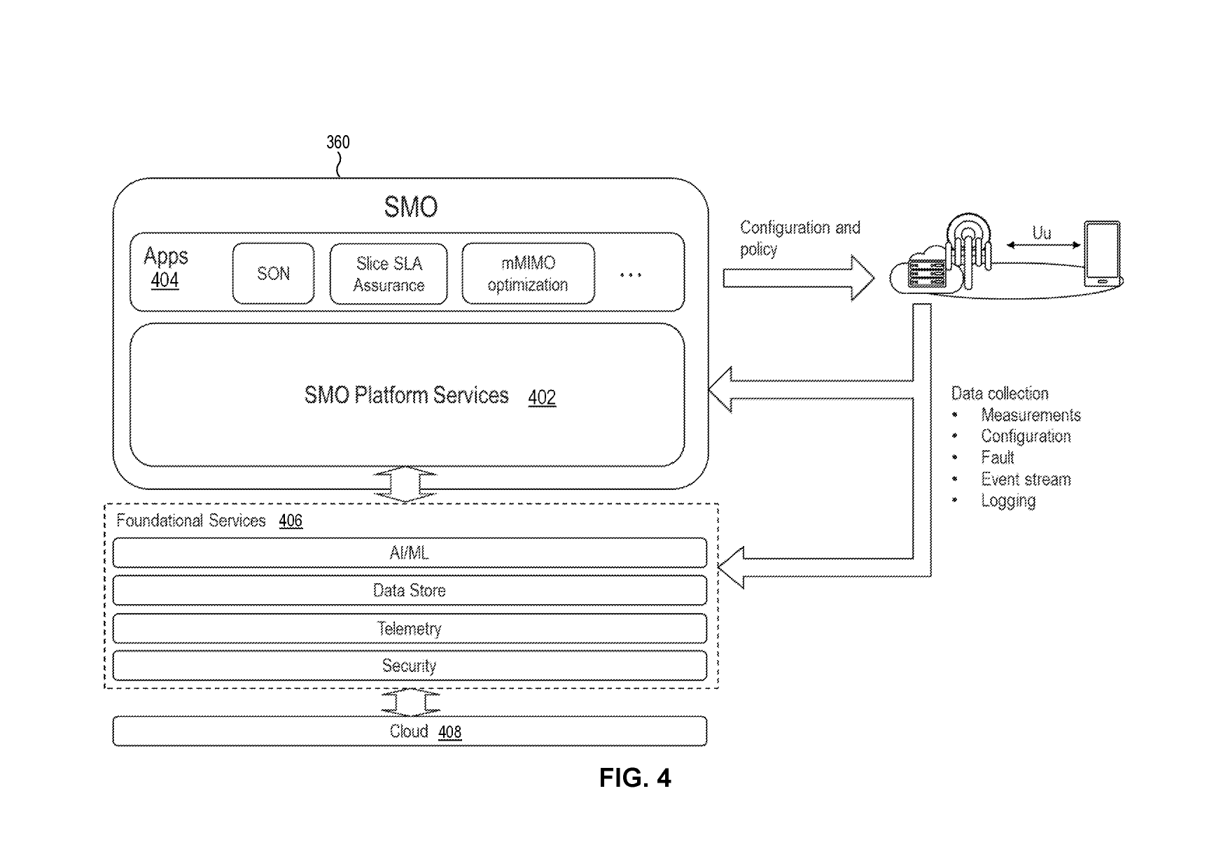

FIG. 4 illustrates a block diagram showing an SMO framework communicating with a network and foundational service components according to aspects of this disclosure. The SMO framework 360 is a component to configure and manage RAN Network Functions (NF) and collect all the events that are reported by different NFs. For example, the SMO framework 360 may collect data (measurements, configuration, fault, event stream, and/or logging) from the NFs (e.g., using the O1 interface). Additionally or alternatively, the SMO framework 360 may provide policies (e.g., for UE to change frequency) or data enrichment to the NFs (e.g., over the A1 interface). The SMO framework 360 may include SMO service components 402 to provide SMO services (e.g., service management, data management, policy management, RAN analytics, service orchestration, topology & inventory, RAN NF orchestration and management, and/or AI/ML workflow). The SMO service components 402 may run on the Non-RT RIC 350 and/or the Near-RT RIC 370 to provide various functionalities (e.g., service management, data management, RAN NF operation administration and maintenance (OAM), policy management RAN analytics, service orchestration, topology & inventory, and/or AI/ML workflow). In some examples, the SMO framework 360 may include applications 404 (rApps and/or xApps) to maximize the network’s operational efficiency. The applications 404 may utilize SMO services to implement a use case for network management to meet the requirements of a use case (e.g., slice service level agreement, mobility performance, and/or spectral efficiency optimization). The SMO framework 360 may be deployed on premises, on the cloud (e.g., telco cloud), or as-a-service to meet the end-user requirements.

In some examples, the SMO framework 360 may communicate with foundational service components 406. Foundational service components 406 may be utilized for collecting data (e.g., measurements, configuration, fault, event stream, and/or logging) and sending control policy or commands to the network. The foundation service components 406 may perform third-party functionalities, which are provided by a cloud platform 408 (e.g., private cloud or public cloud). A third-party foundational service components 406 may provide a functionality on which the SMO framework 360 and the applications 404 can be built, e.g., logging service for containerized applications. Such a service may or may not provide functionality specific to mobile network management. Both the SMO internal services of the SMO framework 360 and the applications 404 may utilize the foundational services for the operations. Although the functionalities are not implemented in the SMO framework 360, the SMO framework 360 may use the functionalities via the foundational service components 406. The foundational service components 406 may include an artificial intelligence or machine learning service component, a data processing and storage service component, a telemetry service component, a security service component, and/or any other suitable service components to be used in the SMO framework 360, and/or network functions. The SMO framework 360 may be configured to use the foundational service components 406 and expose the foundational service components 406 to the applications 404 running in the SMO framework 360. Also, the SMO framework 360 may simplify the interface to communicate with the applications 404 such that a single request from the application 404 may be mapped to multiple operations on the foundational service components 406.

The foundational service components 406 may be logically and/or physically separated from the SMO framework 360. For example, the foundational service components 406 may be in the same cloud server as the SMO framework 360 or a different cloud server from the SMO framework 360. In some examples, the foundational service components 406 may be in the same circuit and/or memory as the SMO framework 360. In other examples, the foundational service components 406 may be the different circuit and/or memory from the SMO framework 360 in the one or more network nodes 110. In further examples, the foundational service components 406 may be in the same cloud server as the SMO framework 360 but in the different circuit and/or memory from the SMO framework 360. The foundational service components 406 may be in a separate server, which is different from the network node including the SMO framework 360. In other examples, the components may be logically separated from the SMO framework 360.

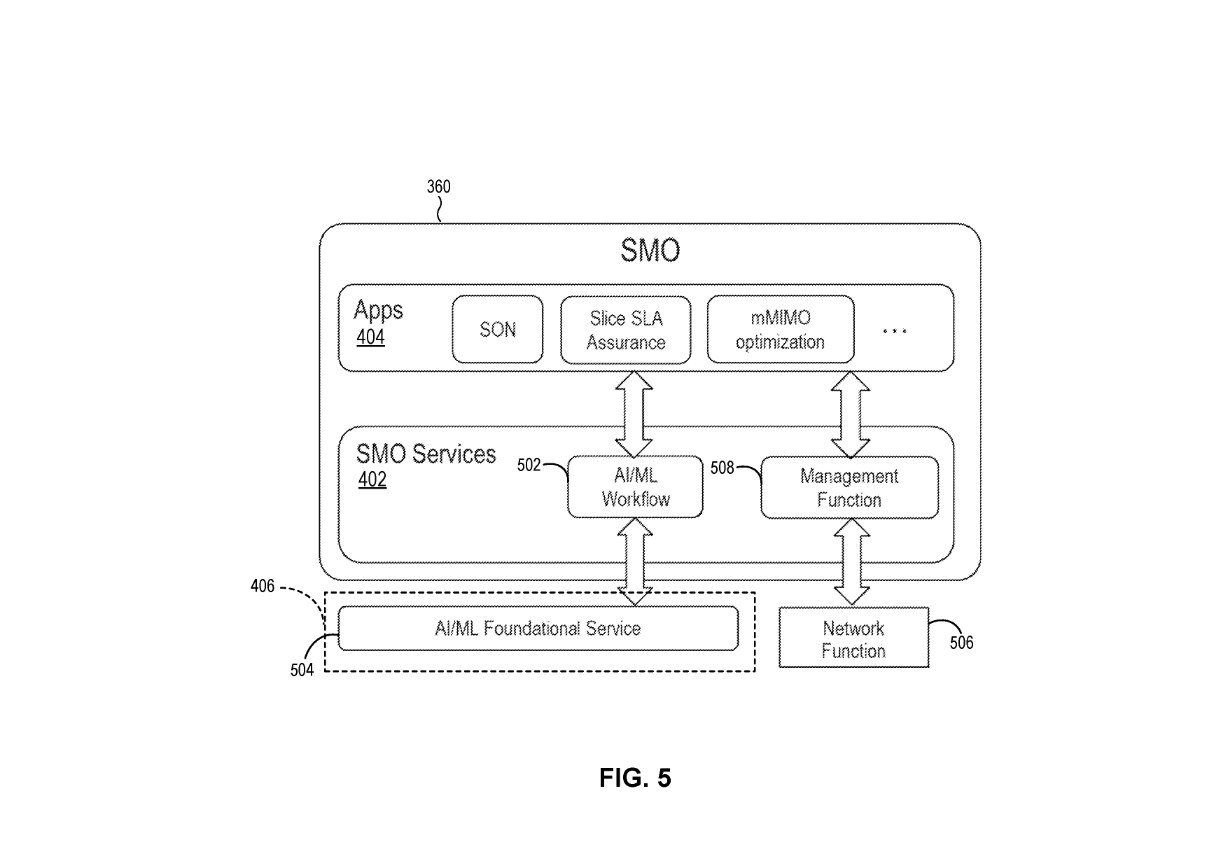

FIG. 5 illustrates a block diagram showing an SMO framework communicating with a foundational service component and a network function according to aspects of this disclosure. For example, the SMO framework 360 may include an AI/ML workflow component 502 among the SMO service components 402. The AI/ML workflow component 502 may operate as an interface between one or more applications 404 in the SMO framework 360 and an AI/ML foundational service component 504 in the foundational service components 406. For example, an application 404 in the SMO framework 360 may request a request to run inference on an AI/ML model, which runs on a third-party AI/ML foundational service component 504. In such examples, the AI/ML workflow component 502 in the SMO framework is configured to orchestrate the processes between the application 404 and the third-party AI/ML foundational service component 504. The AI/ML workflow component 502 may transmit a request to the third-party AI/ML foundational service component 504 to deploy the AI/ML model and configure the data pipeline. For example, the SMO framework 360 may route the input data to the location (e.g., third-party AI/ML foundational service component 504) where the AI/ML model is deployed and provide the output data generated from the AI/ML model to the application 404 running in the SMO framework. In some examples, the several steps to receive the model inference result, the application 404 in the SMO framework 360 may transmit a single request to the AI/ML foundational service component 504. Additionally or alternatively, the AI/ML workflow component 502 may manage AI/ML workflow (e.g., model registry, model training, model deployment and inference, model monitoring, model update or rollback, A/B testing, and/or canary deployment).

In some examples, the SMO framework 360 may communicate with one or more network functions 506 using a management function component 508. For example, the network function may include the CU 310 in FIG. 3, the DU 330 in FIG. 3, the RU 340 in FIG. 3, or any other suitable network functions to control connectivity and data transfer in the RAN. In other examples, the network function may include any suitable network function in the core network 320 in FIG. 3. Thus, the SMO framework 360 may be configured to operate on a RAN domain only, a core network domain only, or both of the RAN domain and the core network domain. In some examples, the management function component 508 of the SMO service components 402 may interconnect between the application 404 and the network function 506. For example, the management function component 508 may manage the AI/ML model in the network by updating the AI/ML model and/or monitoring the performance of the AI/ML model. In some examples, the management function component 508 may be communicatively coupled to a management function of the network function 506 where the management function of the network function 506 is implemented as part of the network function 506. The SMO framework 360 may collect data (e.g., measurements, configuration of the current configuration of the network functions, any fault data, event streams or logging information), and based on the data, the SMO framework 360 may manage the network function 506 to control the wireless communications by providing configuration or policy to the network function 506.

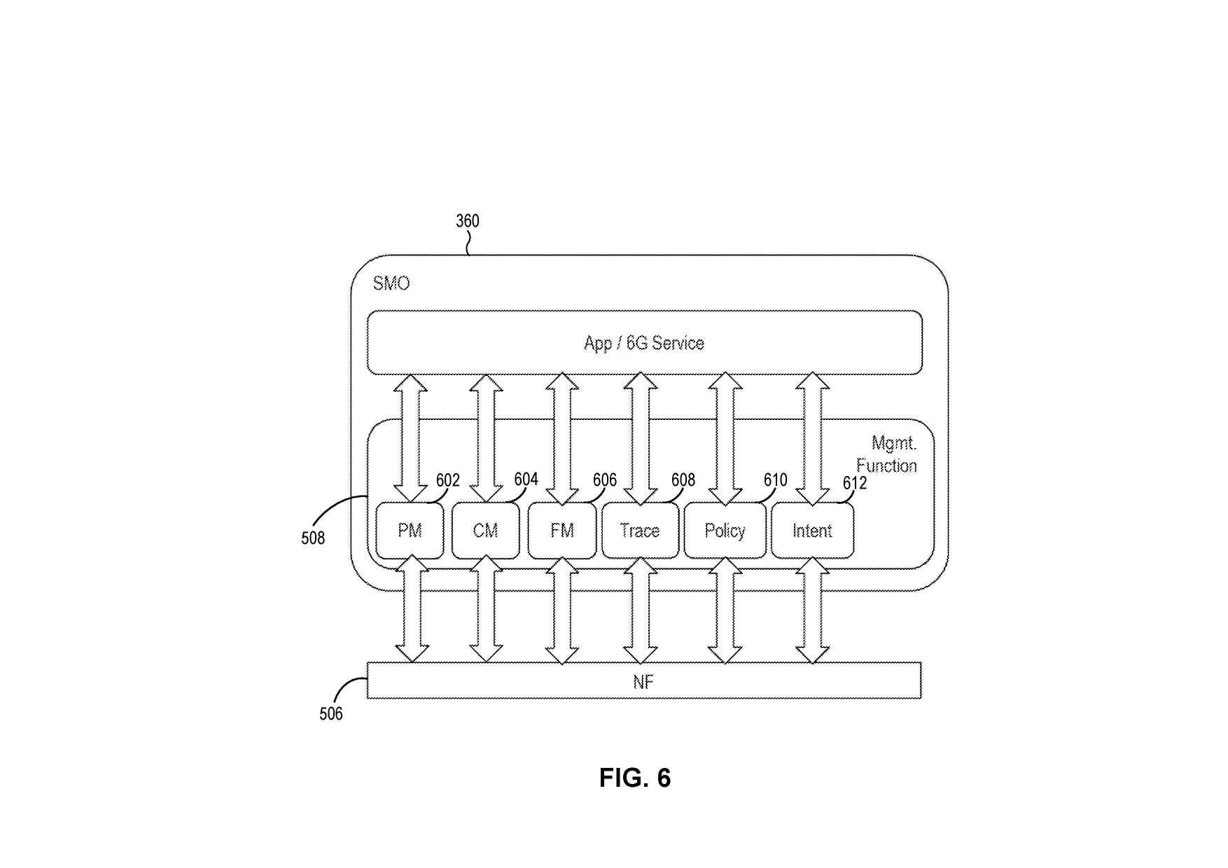

FIG. 6 illustrates a block diagram showing an SMO framework to communicate with network functions according to aspects of this disclosure. Network functions may provide services or functions that the SMO framework 360 can use. For example, the network functions may provide performance management, configuration management, fault management, trace policy management (e.g., management of tracing capability over the network and UE), policy-based control, and/or intent-based management. In some examples, performance management, configuration management, and fault management may be part of a network management model (e.g., fault, configuration, accounting, performance, and security (FCAPS) model). The management function 508 in the SMO framework 360 may have components (e.g., performance management 602, configuration management 604, fault management 606, trace policy management 608 (e.g., management of tracing capability over the network and UE), policy-based control 610 of the network functions 506, and/or intent-based management 612 of the network functions 506. In some examples, performance management 602, configuration management 604, and fault management 606) corresponding to the functions or services that the network functions provide. The components in the management function 508 may include interfaces to communicatively couple the network functions to the SMO service components 402 and/or applications 404 in the SMO framework 360. Then, the SMO framework 360 may be exposed to the services the network functions 506 provided using the interfaces 602-612. For example, policy-based management or control may enable the service consumer to specify a policy to be followed (e.g., switching off a capacity cell when a sector level traffic metric is lower than a threshold). In another example, the intent-based management may allow the service consumer to specify a high-level objective without specifying the objective to be met (e.g., providing a minimum threshold and a maximum latency to a group of users).

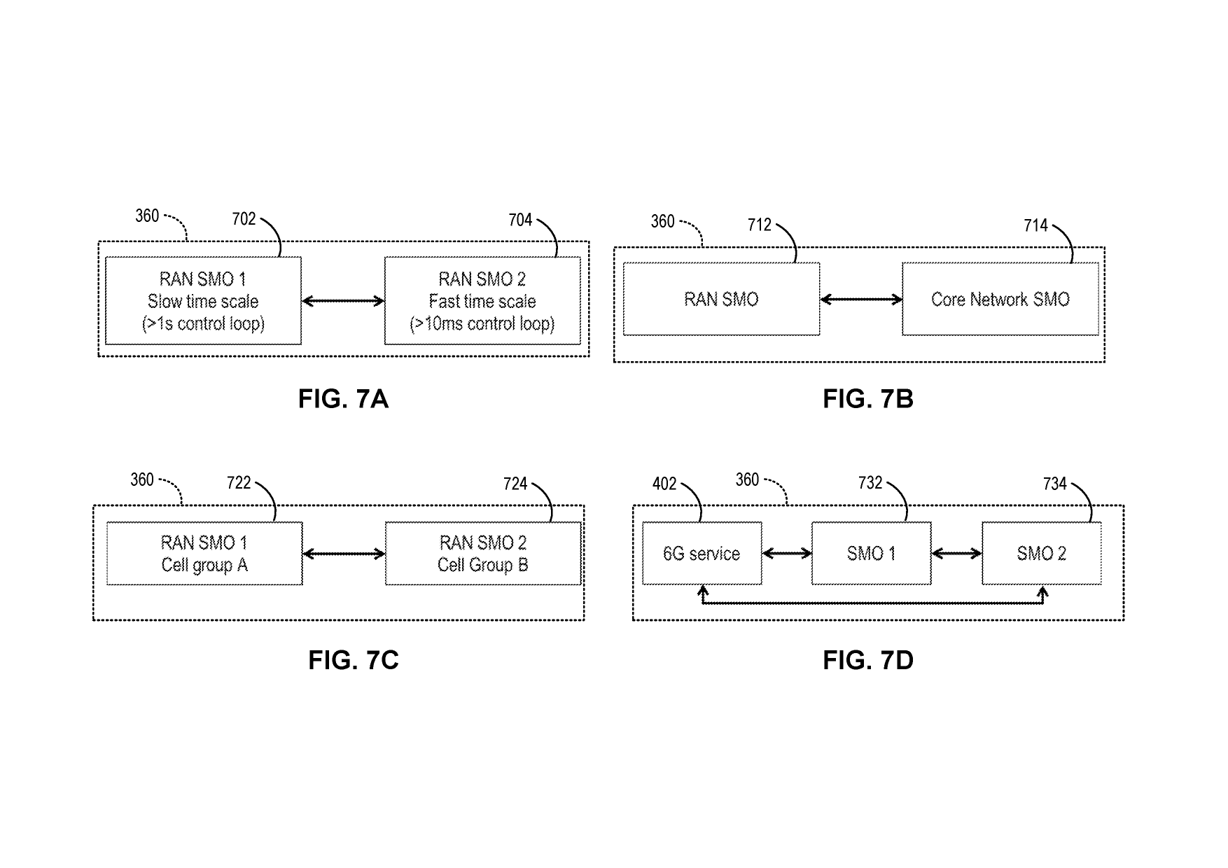

FIGS. 7A-7D show different deployment options of an SMO framework. For example, an SMO framework may include multiple SMO instances with different scopes or capabilities to communicate with each other. In this way, the SMO framework may be flexibly configured and use less memory and power resources than multiple SMO frameworks. In some examples, to include multiple SMO instances in the SMO framework, the SMO framework may configure multiple SMO instances with different configurations to be exposed to different interfaces.

FIG. 7A is a block diagram to show time-scale-based SMO framework deployment according to aspects of this disclosure. In FIG. 7A, the SMO framework 360 may be split into multiple SMO instances based on time scales. For example, the SMO framework 360 may include a first SMO instance 702 for non-real time scale and a second SMO instance 704 for near-real time scale. In some examples, the first SMO instance 702 may include a non-RT RIC 350 in FIG. 3 and SMO service components, which operate on the non-RT RIC 350. The second SMO instance 704 may include a near-RT RIC 370 in FIG. 3 and SMO service components, which operate on the near-RT RIC 370. In some examples, the first and second SMO instances 702, 704 may be configured with interfaces to support operation at different time scales. The first SMO instance 702 may consume RAN FCAPS while the second SMO instance 704 may consume UE level real-time measurements. In other examples, an SMO instance may be similar to the SMO framework 360. In such examples, FIG. 7A shows two different SMO frameworks 360 to communicate each other and manage different time scales. In some examples, applications in the SMO framework 360 may discover the multiple SMO instances and determine SMO instances to operate.

FIG. 7B is a block diagram to show domain-based SMO framework deployment according to aspects of this disclosure. In FIG. 7B, the SMO framework 360 may be split into multiple SMO instances based on domains. For example, the SMO framework 360 may include a first SMO instance 712 to manage a RAN domain and a second SMO instance 714 to manage a core network domain. In some examples, the first and second SMO instances 712, 714 may be configured with interfaces to support operation at different domains. For example, the first SMO instance 712 may consume RAN FCAPS while the second SMO instance 714 may consume core network FCAPS.

FIG. 7C is a block diagram to show cell group-based SMO framework deployment according to aspects of this disclosure. In FIG. 7C, the SMO framework 360 may be split into multiple SMO instances based on different parts or geographical regions of the network. For example, the SMO framework 360 may include a first SMO instance 722 to manage cell group A and a second SMO instance 724 to manage cell group B. Cell group A and B may be configured to have a group of cells. The groups of cells may be configured based on geographical regions. In some examples, the first and second SMO instances 722, 724 may be configured with interfaces (e.g., RAN FCAPS) but configured to operate on different parts or geographical regions of the network (e.g., by configuring a group of cells). Thus, the multiple SMO instances may communicate each other but operate on different parts of the network.

FIG. 7D is a block diagram to show capability-based SMO framework deployment according to aspects of this disclosure. In FIG. 7D, the SMO framework 360 may be split into multiple SMO instances based on SMO service components 402 or applications 404. For example, an SMO service component 402 or an application 404 in the SMO framework 360 may discover capabilities of different SMO instances 732, 734 and interact with the SMO instances 732, 734 based on the capabilities of the SMO instances 732, 734.

In other examples, the SMO framework 360 may include multiple SMO instances using a combination of the deployment options of FIGS. 7A-7D. For example, the SMO framework 360 may include a first SMO instance 702 for the non-real time scale, a second SMO instance 704 for the near-real time scale, a third SMO instance 722 for cell group A, and a fourth SMO instance 724 for cell group B. The SMO framework 360 may include multiple SMO instances based on any other combination of SMO deployment options.

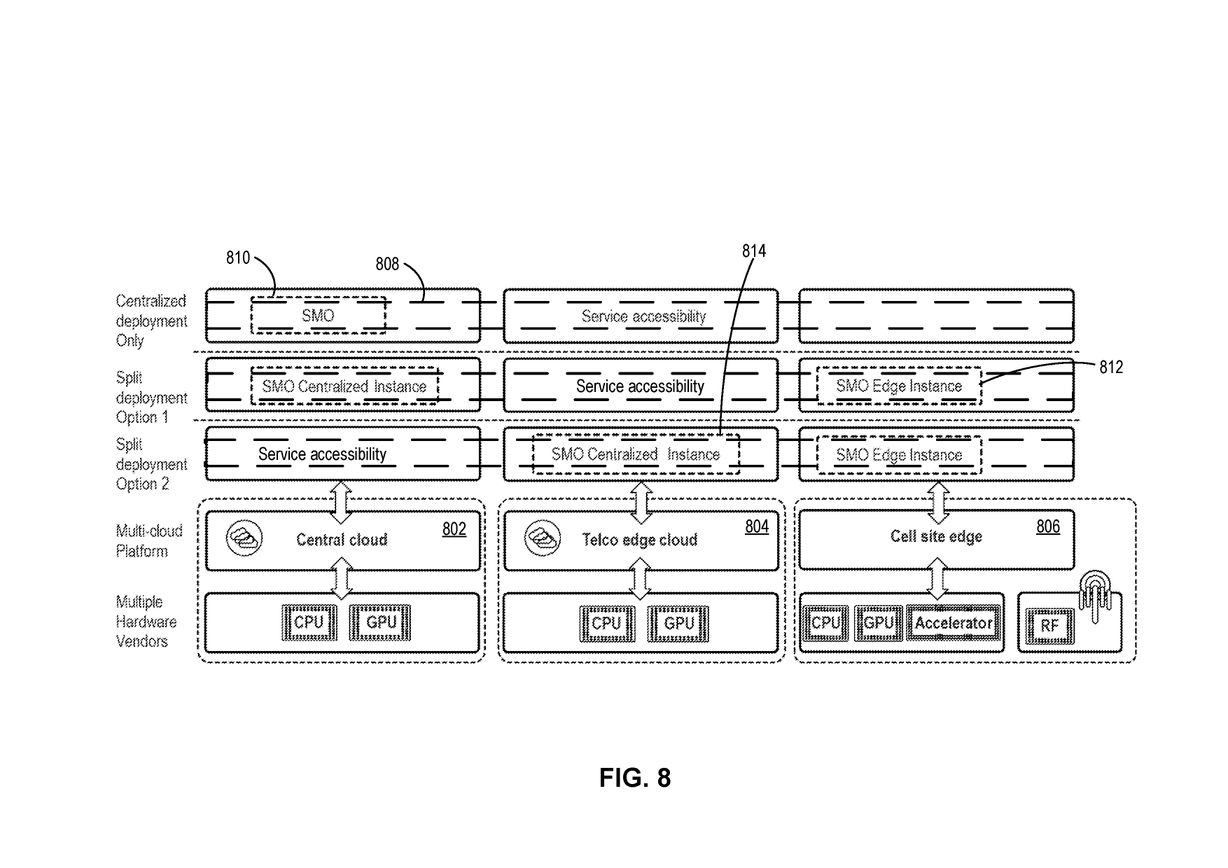

FIG. 8 is a block diagram to show SMO framework deployment in a distributed network according to aspects of this disclosure. The distributed network may include a multi-cloud platform. For example, the distributed network may include a centralized data center, which has a central cloud 802 and/or edge locations 804, 806, which are closer to the cell sites. Across the multi-cloud platform, a virtual private cloud 808 may be configured and defined. The virtual private cloud may create a single network that spans across multiple data centers and locations. Services may be available on the virtual private network. Although the SMO framework can be differently deployed, the services in the SMO framework may be available on the virtual private network and different data centers. In some examples, only one centralized SMO instance 810 may be deployed in the central could 802. In other examples, multiple SMO instances may be deployed, with a centralized SMO instance 810 (e.g., non-real time scale) deployed in the central cloud 802 and an SMO edge instance 812 in the cell site edge 806. In further examples, multiple SMO instances may be deployed, with a centralized SMO instance 814 (e.g., non-real time scale) deployed in a telco edge cloud 804 and an SMO edge instance 812 in the cell site edge 806. In this way, regardless of the various deployment options of the SMO framework 360, the services of the SMO framework are accessible across the data centers in the multi-cloud platform.

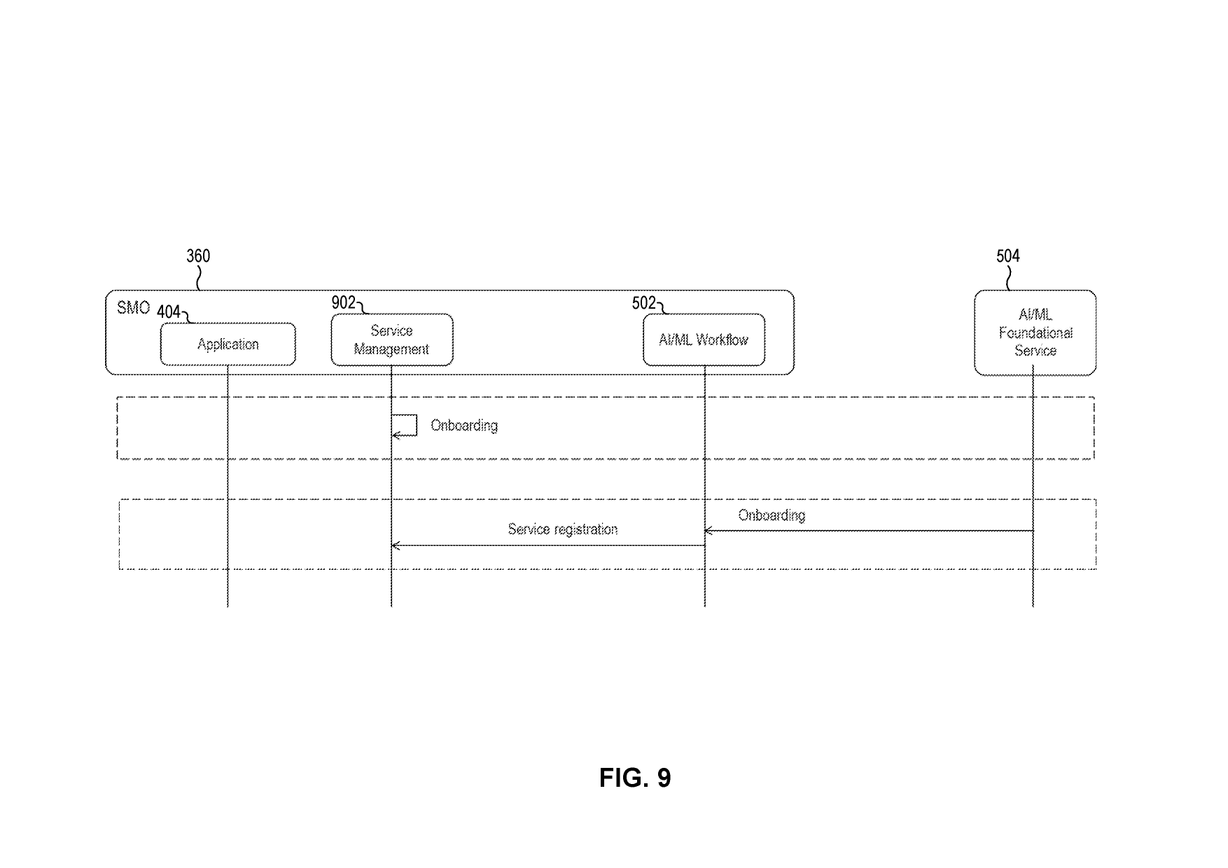

FIG. 9 is a sequence diagram to show an onboarding process of an AI/ML foundational service to integrate the foundational service to an SMO framework according to aspects of this disclosure. To onboard an external or third-party foundational service component in the SMO framework 360, the SMO framework 360 may collect information (e.g., endpoint, API specification, payload, encoding) about the foundational service component and register the foundational service component. In some examples, registering the foundational service component may indicate registering a management service in the service registry. In some examples, the foundational service may be translated before being registered in the service management component 902. In some examples, the SMO framework 360 may translate the foundational service component using a gateway pattern. For example, the SMO framework 360 may allow access to APIs from the foundational service component (e.g., using an AI/ML workflow component 502). In other examples, the SMO framework 360 may translate the foundational service component using an adapter pattern. For example, the SMO framework 360 may translate a data type (payload) or resource structure to be used in an API. In further examples, the SMO framework 360 may translate the foundational service component using a façade pattern. For example, the SMO framework 360 may register a simplified API that maps to a combination of multiple operations in the foundational service component. In even further examples, the SMO framework 360 may perform the translation across service types (e.g., Representational State Transfer API to or from message bus such as Kafka).

In some examples, the SMO framework 360 may register the management service related to the foundational service by internally generating information about the foundational service. For example, the SMO framework 360 may register the AI/ML foundational service component 504 using an internal platform or manually triggered action. The AI/ML foundational service component 504 may provide an external and third-party AI/ML inference functionality. In some examples, the SMO framework 360 may identify information about the AI/ML foundational service component 504 and register the AI/ML foundational service component 504 in the service management component 902 in the SMO framework 360 through proprietary means. For example, an operator may directly register the AI/ML foundational service component 504 by generating or identifying an internal application programming interface (API) in the service registry.

In other examples, the SMO framework 360 may onboard the AI/ML foundational service component 504 by receiving the information about the foundational service from the foundational service component. For example, the SMO framework 360 may register the AI/ML foundational service component 504 based on an API call from AI/ML workflow component 502 in the SMO framework 360 to the service management component 902 in the SMO framework 360. For example, the AI/ML workflow component 502 may receive information about the AI/ML foundational service component 504 and providing the information to the service management to register the AI/ML foundational service component 504 in the service management component 902 in the SMO framework 360.

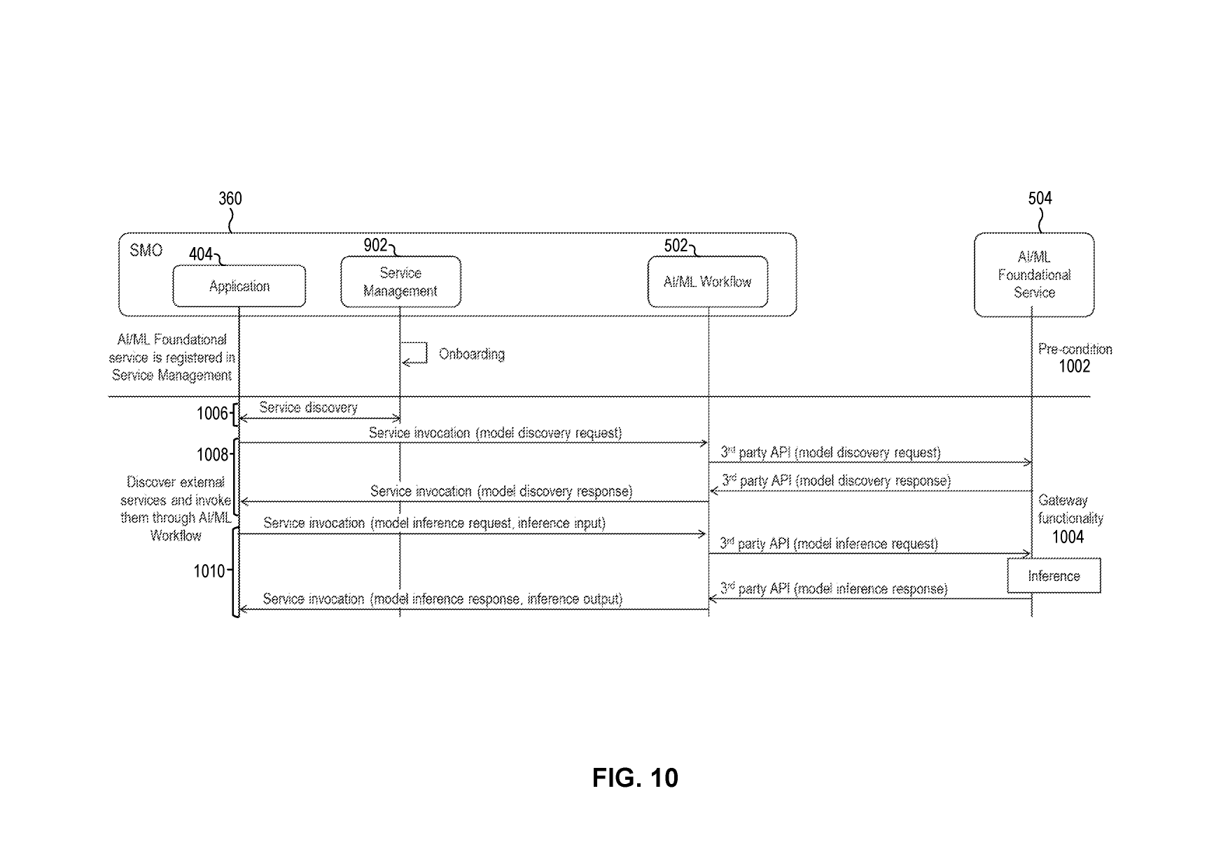

FIG. 10 is a sequence diagram to show integration of a foundational service to an SMO framework according to aspects of this disclosure. The sequence diagram includes two phases: a pre-condition phase 1002 and a gateway functionality phase 1004. In the pre-condition phase 1002, a foundational service component may be registered in the service management component 902 of the SMO framework 360. In some examples, the pre-condition phase 1002 may be similar to the onboarding process described in FIG. 9.

The gateway functionality phase 1004 may include a service discovery step 1006, a model discovery step 1008, and/or a service invocation step 1010. The gateway functionality phase 1004 may provide an example technique to access the foundational service component. However, it is not limited to the gateway functionality to access the foundational service component. For example, any other suitable technique (e.g., using direct access, façade functionality, and/or adapter functionality). In the service discovery step 1006, the SMO framework 360 may discover the AI/ML foundational service component 504 through the service registry in the service management component 902. For example, the application 404 in the SMO framework 360 may transmit a service discovery request to the service management component 902 in the SMO framework 360. The service discovery request may be a request to a specific endpoint with no message body (no input). For example, in RESTful design, the service discovery request may be achieved by sending a GET message to a specific endpoint and resource. Optionally or alternatively, the request may contain filters (e.g., a filter by services that include AI/ML in the name). Then the service management component 902 may identify the AI/ML foundational service component 504 in the service registry and transmit a service discovery response to the application 404. The response may contain a list of service profiles. For example, each service profile may have information such as service name, description, endpoint, supported protocols, and/or supported data formats. The service discovery response may include information about the AI/ML foundational service component 504.

In the model discovery step 1008, the SMO framework 360 may discover an AI/ML model for inference. For example, the application 404 in the SMO framework 360 may transmit a model discover request to the AI/ML workflow component 502 in the SMO framework 360. The AI/ML workflow component 502 may transmit the model discovery request to the AI/ML foundational service component 504 using a third-party API. Then, the AI/ML workflow component 502 may receive a model discovery response from the AI/ML foundational service component 504 using the third-party API. Based on the model discovery response, from the AI/ML foundational service component 504, the AI/ML workflow component 502 may transmit a response corresponding to the model discovery response to the application 404. In some examples, the response may include the AI/ML model or a list of AI/ML models, which are available or accessible in the AI/ML foundational service component 504. For example, the AI/ML workflow component 502 may call a function with an input of the model discovery request to interact with the AI/ML foundational service component 504. Then, the AI/ML workflow component 502 may receive a return with the model discovery response. In some examples, the model discovery response may include a list of available or accessible AI/ML models in the AI/ML foundational service component 504. In response to the model discovery response, the application 404 may select an AI/ML model for inference.

In the service invocation step 1010, the SMO framework 360 may obtain an inference response based on an inference input using the AI/ML model in the AI/ML foundational service component 504. For example, after the application 404 receives the model discovery response, the application 404 in the SMO framework 360 may transmit a request to the AI/ML workflow component 502 in the SMO framework 360. The request may include a request to deploy the AI/ML model, an inference input to the AI/ML model, and/or an inference request to perform inference using the AI/ML model. Then, the AI/ML workflow may call a function (e.g., a third-party API) to transmit the request to the AI/ML foundational service component 504. In some examples, in response to the request to deploy the AI/ML model, the AI/ML foundational service component 504 may deploy the AI/ML model in the network. To deploy the AI/ML model, the AI/ML foundational service component 504 may integrate the AI/ML model in the network. Deployment of an AI/ML model may indicate that hardware and software allocations are made so that inference can be performed using the AI/ML model. For example, hardware resources may be allocated (e.g., GPU resources), software required to perform inference may be “loaded” (deployed). Software may include data processing (convert input data to features that can be used for inference), AI/ML model (architecture and parameters) inference (code that performs inference). Once an AI/ML model is deployed, optionally or alternatively, an additional software layer may be available that exposes an API (e.g., REST API). A consumer can make an inference request by calling that API. The API server then may pass the input to the software layer that perform data processing and inference. Once the output is available, API server may return the output to the consumer. In some examples, in response to the inference input and the inference request, the AI/ML foundational service component 504 may perform inference. The inference may include providing the inference input to the AI/ML model and receiving an inference output from the AI/ML model. In some examples, the inference input and output may not be registered as data types in the data management component in the SMO framework 360. In such examples, the application 404 may provide the inference input and obtain inference output through the model inference API from the AI/ML foundational service component 504. In other examples, the data management component may manage the inference input and output data. In such examples, the application 404 may provide the inference input to the data management component, which converts the inference input to a data format that the AI/ML workflow component 502 can use to call the model inference API. Similarly, the data management component may receive the inference output from the AI/ML workflow component 502 and convert to a data format that the application 404 uses.

The AI/ML model may have different architectures (e.g., number of layers, type of layers, ordering of layers, connections between layers, hyperparameters for layers) to improve communications in the network. In some configurations, the AI/ML model may be structured as a single-layer perceptron network, in which a single layer of output nodes is used, and inputs are fed directly to the outputs by a series of weights. In other configurations, the AI/ML model can be structured as multilayer perceptron networks, in which the inputs are fed to one or more hidden layers before connecting to the output layer. As one example, the AI/ML model may be configured as a feedforward network, in which the connections between nodes do not form any loops in the network. As another example, the AI/ML model may be configured as a recurrent neural network (“RNN”), in which connections between nodes are configured to allow for previous outputs to be used as inputs while having one or more hidden states, which in some instances may be referred to as a memory of the RNN. RNNs are advantageous for processing time-series or sequential data. Examples of RNNs include long-short term memory (“LSTM”) networks, networks based on or using gated recurrent units (“GRUs”), or the like.

The AI/ML model may be structured with different connections between layers. In some instances, the layers are fully connected, in which each all of the inputs in one layer are connected to each of the outputs of the previous layer. Additionally or alternatively, neural networks can be structured with trimmed connectivity between some or all layers, such as by using skip connections, dropouts, or the like. In skip connections, the output from one layer jumps forward two or more layers in addition to, or in lieu of, being input to the next layer in the network. An example class of the AI/ML model that implement skip connections includes residual neural networks, such as ResNet. In a dropout layer, nodes are randomly dropped out (e.g., by not passing their output on to the next layer) according to a predetermined dropout rate. In some embodiments, the AI/ML model may be configured as a convolutional neural network (“CNN”), in which the network architecture includes one or more convolutional layers. Additionally or alternatively, the AI/ML model may use supervised learning or unsupervised learning to be configured as a trained model. The AI/ML model is not limited to the models described above, but any other suitable AI/ML model can be used to improve communications in the network.

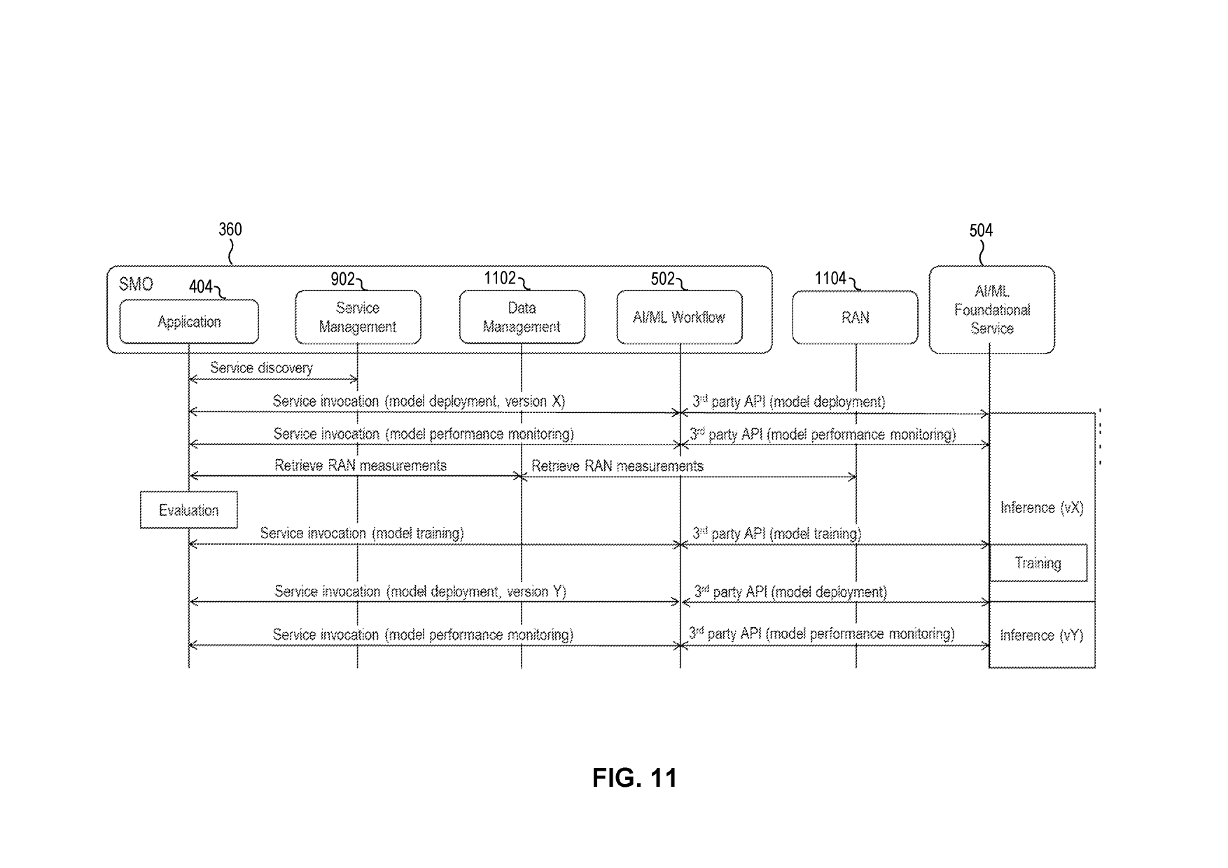

FIG. 11 is a sequence diagram to show integration of a foundational service to an SMO framework according to aspects of this disclosure. The sequence diagram may include AI/ML model lifecycle management. For example, the application 404 may deploy version X of an AI/ML model and determine to train and deploy a new AI/ML model based on one or more factors (e.g., AI/ML model performance and/or RAN performance). In such examples, the retraining the AI/ML model may be orchestrated such that the application 404 may control each step to retrain the AI/ML model.

In some examples, the application 404 in the SMO framework 360 may discover the AI/ML foundational service component 504 as described in the service discovery phase 1006 in FIG. 10. Additionally or alternatively, the application 404 in the SMO framework 360 may discover the AI/ML model as described in the model discovery step 1008 in FIG. 10. In some examples, the application 404 may determine the AI/ML model for inference and/or a version of the AI/ML model based on the model discovery.

When the application 404 determines a version of the AI/ML model, the application 404 may transmit a request to deploy the version of the AI/ML model to the AI/ML foundational service component 504 using the AI/ML workflow component 502 in the SMO framework 360 (e.g., using a third-party API to request model deployment to the AI/ML foundational service component 504). Based on the API call, the AI/ML foundational service component 504 may deploy the version of the AI/ML model. Then, the application 404 may request to perform model performance monitoring to the AI/ML foundational service component 504 via the AI/ML workflow component 502 in the SMO framework 360 (e.g., using a third-party API to request model performance monitoring to the AI/ML foundational service component 504). In some examples, model performance monitoring may be monitoring of how well the AI/ML model performs on new input data. For supervised learning models, the performance may be measured by comparing the model output (prediction) with ground truth (if available). The performance metric may be the absolute difference, square of difference, etc. An AI/ML model may not perform well after deployment due to a variety of reasons. The input data statistics may have changed (data drift), e.g., the model is trained with few cases of low signal strength but in production many cases with low signal strength are seen. The environment may have changed since model was trained, e.g., consumer behavior changed at the start of COVID-19 pandemic resulting in high error rates in credit card fraud detection systems.

The application 404 may retrieve RAN information (e.g., RAN measurements and/or RAN configuration) from the RAN 1104 via the data management component 1102 in the SMO framework 360. Data management service in the data management component 1102 may provide common services for data discovery, request and delivery. The data management service may provide a data registry where data producers can register the data types that they produce. Data consumers may discover the registered data types and determine which data types would be useful for them. This may decouple data consumers from data producers. For example, data consumers may focus on the needed data type without worrying about data producers (e.g., regardless that two data producers produce the same data type or one data producer for a geographic region (WEST) and the other data producer for another geographic region (e.g., EAST)). Data request and subscriptions may be handled by the data management service to enable optimizations in data delivery. For example, if multiple consumers want to consume the same data type, the data producer could still produce each data sample once, but data management may manage the subscriptions and delivery of the same data sample to multiple consumers. In some examples, the RAN management function may act as a data producer and registers a data type for RAN performance measurements in the data management. Examples of a performance measurement may include the number of active users and/or DL PRB utilization. These are measured over a time period (e.g., 15 min). An application can discover data types and it may find that RAN performance measurements data type is available. It can send a request to data management to obtain the latest sample, or may even create a subscription for these performance measurements. In case of the request (one-time), Data Management can provide the performance measurement sample if it already has it, or it may obtain it from RAN management service and then provide it to the application.

In some examples, the data management component 1102 of the SMO framework 360 may receive and store the RAN measurements (e.g., using the processor or RIC) and provide the measurements to the application 404. Then, the application 404 may determine to retrain the AI/ML model based on the model performance and RAN measurements. For example, the application 404 may determine that the AI/ML model performance affects the RAN performance. For example, when the AI/ML model performance shows underperformance, the RAN measurements may also indicate underperformance of the RAN. In such examples, the application 404 may determine to retrain the AI/ML model. Then, the application 404 may transmit a request to retrain the AI/ML model to the AI/ML workflow component 502, which transmits the request to the AI/ML foundational service component 504 (e.g., using a third-party API). The AI/ML foundational service component 504 may retrain the AI/ML model based on the request. Then, the application 404 may transmit a request to deploy the updated version of the AI/ML model to the AI/ML foundational service component 504 using the AI/ML workflow component 502 in the SMO framework 360. The application 404 may monitor the performance of the updated AI/ML model.

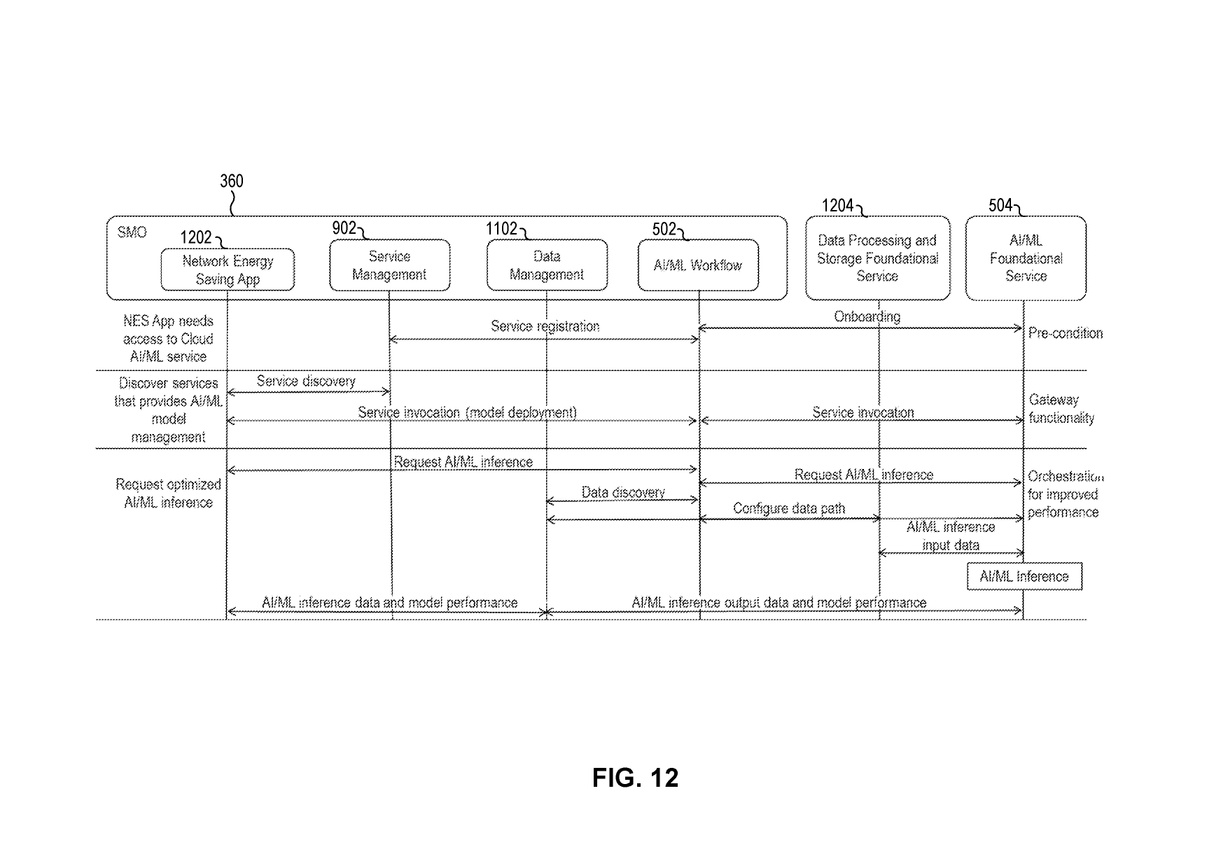

FIG. 12 is a sequence diagram to show integration of a foundational service to an SMO framework according to aspects of this disclosure. FIG. 12 shows a use case using a network energy saving application 1202 in the SMO framework 360 and the AI/ML foundational service component 504 to improve network energy usage. The network energy saving application 1202 in the SMO framework 360 may use the cloud AI/ML foundational service component 504. To use the AI/ML foundational service component 504, the SMO framework 360 may onboard or register the AI/ML foundational service component 504. In some examples, the registration of the AI/ML foundational service component 504 may be similar to the onboarding process described in FIG. 9. Additionally or alternatively, the AI/ML workflow component 502 of the SMO framework 360 may register the AI/ML foundational service component 504.

When the service of the AI/ML foundational service component 504 is registered in the service management component 902, the network energy saving application 1202 may discover the AI/ML foundational service component 504 in the service management component 902. Then, the network energy saving application 1202 may invoke a service based on the discovered AI/ML foundational service component 504. For example, the service invocation may call a third-party API to deploy an AI/ML model for inference in the AI/ML foundational service component 504. In some examples, the network energy saving application 1202 may transmit a request to deploy the AI/ML model to the AI/ML workflow component 502, which translate the request to call the third party API to deploy the AI/ML model. In such way, the AI/ML model and the AI/ML foundational service component 504 may be integrated into the SMO framework 360. Then, the AI/ML foundational service component 504 may deploy the AI/ML model.

Then, the network energy saving application 1202 may request inference to the AI/ML foundational service component 504 using a third-party API to improve performance of the network. The SMO framework 360 provides efficient and seamless data movement and data discovery using the AI/ML workflow component 502. For example, the network energy saving application 1202 may transmit a request for inference to the AI/ML workflow component of the SMO framework 360. For example, the network energy saving application 1202 may receive a request relating to use of an external application (e.g., an AI/ML model of the AI/ML foundational service component 504). In some examples, the request may be received from an entity, which is external to the SMO framework 360 or generated in the network energy saving application 1202. In some examples, the request may include input data to the AI/ML model of the AI/ML foundational service component 504. In other examples, the request may include an indication to use the AI/ML model. The network energy saving application 1202 may transmit the request to the AI/ML workflow component 502 of the SMO framework 360.

The AI/ML workflow component 502 may receive the request from the network energy saving application 1202 and transmit a second request corresponding to the request to the AI/ML foundational service component 504. For example, the second request may include a third-party function call or API to use the deployed AI/ML model for inference. The API may be defined in the AI/ML foundational service component 504. The API may also include the input data to be applied to the AI/ML model in the AI/ML foundational service component 504. In other examples, the input data to be applied to the deployed AI/ML model may be transmitted to the AI/ML foundational service component 504 from other component or entity. The AI/ML workflow component 502 may communicate with another third-party foundational service component (e.g., data processing and storage foundational service component 1204) to provide input data to the AI/ML foundational service component 504 for inference. For example, when the AI/ML workflow component 502 receives the request from the network energy saving application 1202, the AI/ML workflow component 502 may discover data in the data management component 1102 of the SMO framework 360. For example, the AI/ML workflow component 502 may create a data type for inference input data in the data management component 1102 (e.g., when the data management component is involved in collection and processing of inference input data) and a data type for inference output data in the data management component 1102. Then, the AI/ML workflow component 502 may configure a data path to the data processing and storage foundational service component 1204 and/or the AI/ML foundational service component 504 based on the data discovery with the data management component 1102.

When data path is not configured, the application 1202 may collect the input data for an AI/ML model. The application 1202 may send the input data as part of inference request to AI/ML workflow component 502, which may forward the inference request (with the input data) to the AI/ML foundational service component 504. In such examples, data may traverse multiple services. Instead of application fetching the input data and then sending it to the AI/ML foundational service, a path for data flow may be created from the source of that data to the AI/ML foundational service to reduce the cost of data movement. For example, RAN performance and configuration data is written to a software platform (e.g., Kafka) (onto different topics). The input data for a specific AI/ML model may be created by reading data from the software platform, processing it, and then writing the model input data into a new topic (Z). Configuring a data path may mean that a rule may be set up such that data from topic Z is read and sent to AI/ML foundational service for an inference using model. Each time a new data sample is available in topic Z, the inference using model may be be triggered. In such examples, the application, data management, and AI/ML workflow may not be involved after the data path is set up. Based on the configured data path, the data processing and storage foundational service component 1204 may directly provide the input data for inference to the AI/ML foundational service component 504. In other examples, the configured data path may be shared by the AI/ML foundational service component 504. In such examples, the AI/ML foundational service component 504 may access the input data in the data processing and storage foundational service 1204 based on the configured data path. Then, the AI/ML foundational service component 504 may apply the input data to the AI/ML model.

The AI/ML model may generate an AI/ML inference output and/or model performance data when the AI/ML foundational service component 504 applies the input data to the AI/ML model. For example, the data management component 1102 of the SMO framework 360 may receive the inference output and/or model performance data and provide the inference output and/or model performance data to the network energy saving application 1202. In other examples, the data management component 1102 may store the inference output and/or model performance data, and the network energy saving application 1202 may access the inference output and/or model performance data in the data management component 1102.

In some examples, the network energy saving application 1202 of the SMO framework 360 may be deployed in operator networks to collect traffic data during the day. Then, the network energy saving application 1202 may receive a request to predict data traffic at a certain time (e.g., at 11:00 pm, between 10:00 pm and 6:00 am, 2 hours later, or any other suitable time) and transmit the request to the AI/ML foundational service component 504 via the AI/ML workflow component 502. In some examples, the request may include the collected traffic data during the data as well. In other examples, the network every saving application 1202 may store the traffic data in the data processing and storage foundational service component 1204 that the AI/ML foundational service component 504 can access. Then, the AI/ML foundational service component 504 may apply the traffic data to the AI/ML model to predict the data traffic at the time based on the request. In such examples, the SMO framework 360 and/or the network energy saving application 1202 may transmit an instruction for wireless communication based on the result of the AI/ML model. In some examples, the result of the AI/ML model include inference using the AI/ML model. For example, when the predicted data traffic is low at the certain time, the SMO framework 360 and/or the network energy saving application 1202 may transmit an instruction to switch off some cells on a tower covering the same geographical area and maintain the other cells on the tower. The network traffic may not just be controlled based on a historical pattern but based on the current data traffic. Thus, the network energy on the tower can be saved based on the data traffic on the network.

In some examples, the SMO framework 360 may de-configure the data pipeline and remove the deployed AI/ML model when the AI/ML model is no longer used (e.g., when all the services of the application that requested model deployment for the specific model have notified that the application does not use the inference).

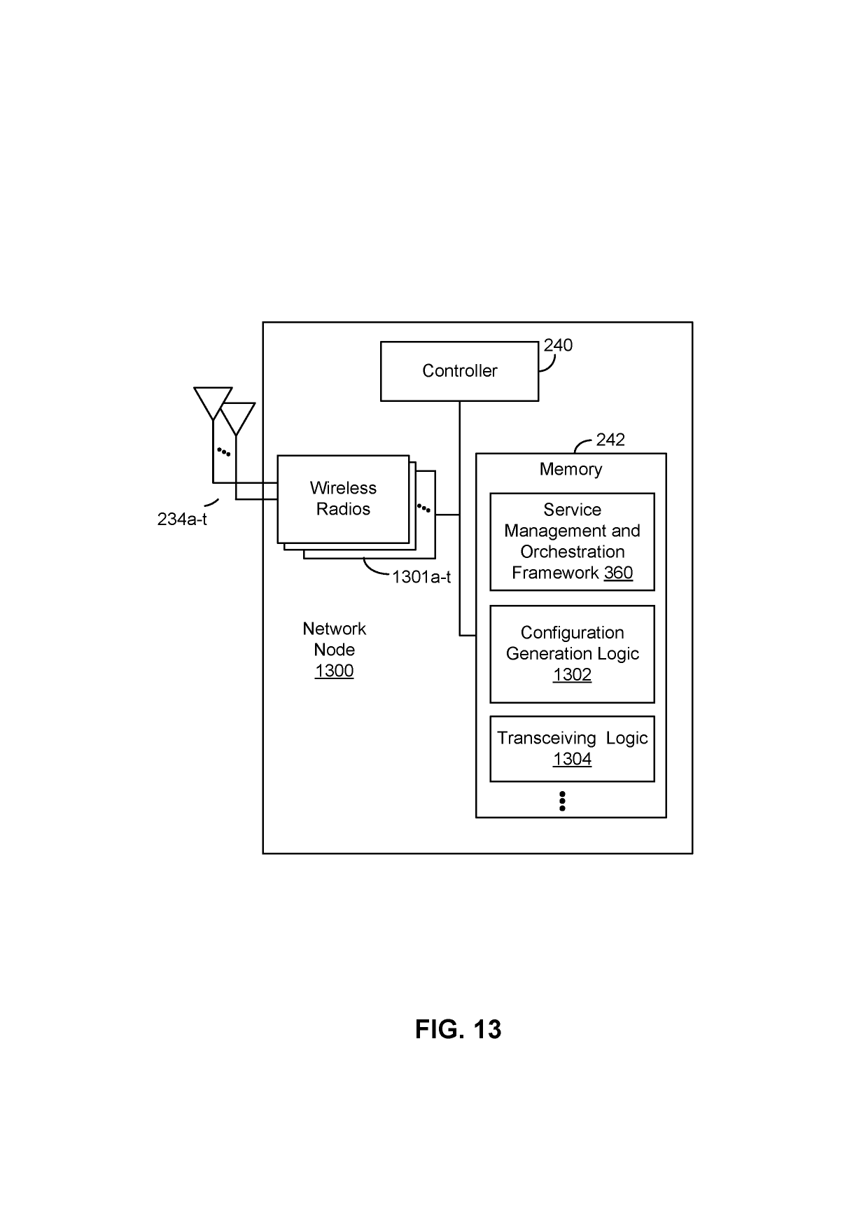

FIG. 13 is a block diagram of an example network node 1300 that SMO framework configuration for external functionalities according to one or more aspects. The network node 1300 may be configured to perform operations, including the blocks of the process 1400 described with reference to FIG. 14, respectively. In some implementations, the network node 1300 includes the one or more chips, SoCs, chipsets, packages, structure, hardware, and components shown and described with reference to the network node 105 of FIGS. 1-3. Additionally or alternatively, the network node 1300 may be included in the central server 702, the telco edge cloud server 704, and/or the cell site edge server 706. For example, the network node 1300 may include the controller 240, which operates to execute logic or computer instructions stored in the memory 242, as well as controlling the components of the network node 1300 that provide the features and functionality of the network node 1300. The network node 1300, under control of the controller 240, transmits and receives signals via wireless radios 1301a-t and the antennas 234a-t. The wireless radios 1301a-t include various components and hardware, as illustrated in FIG. 2 for the network node 105, including the modulator and demodulators 232a-t, the transmit processor 220, the TX MIMO processor 230, the MIMO detector 236, and the receive processor 238.

As shown, the memory 242 may include an SMO framework 360 in FIG. 3, a configuration generation logic 1302, and a transceiving logic 1304. The SMO framework 360 may the application 404 in FIG. 4, the network energy saving application 1202 in FIG. 12, the service management component 902 in FIG. 9, the data management component 1102 in FIG. 11, and/or the AI/ML workflow component 502 in FIG. 5. The SMO framework 360 may be deployed in one network node 1300, a central server 702 in FIG. 7, a telco edge server 704, and/or a cell site edge server 706. In some examples, the SMO framework 360 may also include a hardware component (e.g., controller 240 and/or wireless radios 1301a-t). The configuration generation logic 1302 may configure and orchestrate the SMO framework 360 to communicate with external entity and use external functionalities. The transceiving logic 1304 of the network node 1300 may be configured to transmit signals (e.g., receiving a first request relating to use of an external application, transmitting a second request relating to performance of the external application, receiving an indication of a result corresponding to the second request, transmitting an instruction for wireless communication based on the indication, and/or transmitting or receiving any other suitable signals) to one or more external entities (e.g., the data processing and storage foundational service component 1204 in FIG. 12, the AI/ML foundational service component 504 in FIG. 5, the RAN 1104 in FIG. 11.

In some implementations, the network node 1300 may be configured to perform the process 1400 of FIG. 14. To illustrate, the network node 1300 may execute, under control of the controller 240 (e.g., Non-RT RIC and/or Near-RT RIC), the configuration generation logic 1302 and the transceiving logic 1304 stored in the memory 242. The execution environment of the configuration generation logic 1302 provides the functionality to perform at least the operations in block 1402. The execution environment of the transceiving logic 1304 provides the functionality to perform at least the operations in blocks 1402 and 1404 in FIG. 14.

FIG. 14 illustrates a method 1400 for wireless communication at a network node according to aspects of this disclosure. According to some aspects, the network node is a network node is a network entity, such as a base station as described in any of FIGS. 1-3 and the network node 1300 in FIG. 13.

At block 1402, the network node transmits, by an SMO framework from a first entity, a first request relating to use of an external application. In some examples, the SMO framework is similar to the SMO framework 360 in FIGS. 3-13. The first entity may include an application in the SMO framework 360. The application may be similar to rApp or xApp in FIG. 4, the application 404 in FIGS. 4, 5, and 9-12. The external application may be in a second entity, which is a third-party foundational service component providing external functionalities. For example, the foundational service component may be similar to the foundational service component 406 in FIG. 4 (e.g., AI/ML foundational service component 504 in FIGS. 5 and 9-12). The foundational service component may be in the same or different cloud server. In some examples, the external application comprises an artificial intelligence or machine learning (AI/ML) model. The AI/ML model is similar to the AI/ML model in FIGS. 9-12.

In some examples, the network node may register the external application. In some examples, the registering of the external application may be similar to the onboarding process of the AI/ML foundational service component 504 in FIG. 9. For example, the network node may retrieve information associated with the external application in a memory to register the external application or receive the information associated with the external application from the second entity to register the external application. Additionally or alternatively, the network node may identify the external application using a discovery operation in the SMO framework. In some examples, the identifying of the external application is similar to the service discovery in FIG. 10.

In some examples, the SMO framework may be configured to operate on a radio access network domain only, a core network domain only, or both of the radio access network domain and the core network domain. In other examples, the SMO framework may be configured to operate on a specific function or a scope of the wireless communications. In some examples, the configuration of the SMO framework is similar to the deployment of the SMO framework in FIGS. 7A-7D and 8. Additionally or alternatively, the SMO framework comprises a non-real time intelligent controller (Non-RT RIC) and near-real time intelligent controller (Near-RT RIC) to support different time scale operations. In some examples, the controller in the SMO framework may be similar to the Non-RT RIC and the Near-RT RIC in FIG. 3.

At block 1404, the network node transmits, by the SMO framework to a second entity, a second request relating to performance of the external application. In some examples, the second request may be transmitted by routing the first request or mapping the first request to the second request to cause the second entity to receive. In some examples, the second entity may be similar to the foundational service component 406 in FIG. 4 (e.g., AI/ML foundational service component 504 in FIGS. 5 and 9-12). Also, the second request may be similar to the request or the third-party API transmitted by the AI/ML workflow component 502 to the AI/ML foundational service component 502 in FIGS. 10-12. The second request may also include the AI/ML inference output data and/or model performance.

In some examples, the network node may configure a data path based on the second request for input data to be transmitted by a third entity to the second entity and transmit the data path to the third entity. The indication of the result may be in response to the input data from the third entity. In some examples, the third entity may be similar to the data processing and storage foundational service component 1204 in FIG. 12 or any other suitable third-party foundational service component. The data path configuration may be similar to the data discovery, the data path configuration, and AI/ML inference input data transmission in FIG. 12.

When the external application is the AI/ML model, the network node may transmit a third request to deploy the AI/ML model to the second entity and receive endpoint information for accessing the deployed AI/ML model in response to the third request. In some examples, the third request may be the request to deploy the AI/ML model in FIGS. 10-12 In further examples, the second request may include inference input data for the AI/ML model. The inference input data may be similar to the inference input data in FIGS. 10-12. In such examples, the network node may determine the inference input data based on data collected from the wireless communications and determine an output data type for the indication of the result of the AI/ML model. For example, the data collected from the wireless communications may be similar to RAN measurements in FIG. 11. Additionally or alternative, the network node may determine at least one measurement of the wireless communications or the AI/ML model, determine a training request of the AI/ML model or a new model based on the at least one measurement, and transmit the training request of the AI/ML model or the new model to the second entity. In some examples, the AI/ML model training is similar to the model training and deployment in FIG. 11.

At step 1406, the network node receives, by the SMO framework from the second entity, an indication of a result corresponding to the second request transmitted to the second entity. The indication of the result may be similar to the AI/ML inference output and/or model performance data in FIGS. 10-12.

At step 1408, the network node transmits an instruction for wireless communication based on the indication. In some examples, the instruction for wireless communication is similar to the instruction in FIG. 12.

Implementation examples are described in the following numbered clauses:

Clause 1: A method for wireless communication, the method comprising: receiving, by an SMO framework from a first entity, a first request relating to use of an external application; transmitting, by the SMO framework to a second entity, a second request relating to performance of the external application; receiving, by the SMO framework from the second entity, an indication of a result corresponding to the second request transmitted to the second entity; and transmitting an instruction for wireless communication based on the indication.

Clause 2: The method of Clause 1, further comprising: configuring a data path between the third entity and the second entity based on the second request for input data to be transmitted by a third entity to the second entity; and transmitting the data path to the third entity, the indication of the result being in response to the input data from the third entity.

Clause 3: The method of Clause 1 or 2, wherein the second request is transmitted by routing the first request or mapping the first request to the second request to cause the second entity to receive.

Clause 4: The method of one or more of Clause 1 through Clause 3, wherein the external application comprises an artificial intelligence or machine learning (AI/ML) model, and wherein the method further comprises: transmitting a third request to deploy the AI/ML model to the second entity; and in response to the third request, receiving endpoint information for accessing the deployed AI/ML model.

Clause 5: The method of one or more of Clause 1 through Clause 4, wherein the second request comprises inference input data for the AI/ML model, and wherein the method further comprises: determining the inference input data based on data collected from the wireless communications; and determining an output data type for the indication of the result of the AI/ML model.

Clause 6: The method of one or more of Clause 1 through Clause 5, further comprising: determining at least one measurement of the wireless communications or the AI/ML model; determining a training request of the AI/ML model or a new model based on the at least one measurement; and transmitting the training request of the AI/ML model or the new model to the second entity.

Clause 7: The method of one or more of Clause 1 through Clause 6, wherein the SMO framework is configured to operate on a radio access network domain only, a core network domain only, or both of the radio access network domain and the core network domain.

Clause 8: The method of one or more of Clause 1 through Clause 7, wherein the SMO framework is configured to operate on a specific function or a scope of the wireless communications.

Clause 9: The method of one or more of Clause 1 through Clause 8, further comprising: registering the external application, wherein registering the external application comprises: retrieving information associated with the external application in a memory to register the external application, or receiving the information associated with the external application from the second entity to register the external application.

Clause 10: The method of one or more of Clause 1 through Clause 9, further comprising: identifying the external application using a discovery operation in the SMO framework.

Clause 11: The method of one or more of Clause 1 through Clause 10, wherein the SMO framework comprises a non-real time intelligent controller (Non-RT RIC) and near-real time intelligent controller (Near-RT RIC) to support different time scale operations.

Clause 12: An apparatus configured to operate as a Service Management and Orchestration (SMO) framework, the apparatus comprising: at least one processor to configure the SMO framework to perform operations comprising: the method of one or more of Clause 1 through Clause 11.

Clause 13: A computer-readable storage medium that stores instructions for execution by one or more processors of a Service Management and Orchestration (SMO) framework, the instructions to configure the SMO framework to perform operations comprising: the method of one or more of Clause 1 through Clause 11.

In the figures, a single block may be described as performing a function or functions. The function or functions performed by that block may be performed in a single component or across multiple components, or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure. Also, the example devices may include components other than those shown, including well-known components such as a processor, memory, and the like.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, the term “determine” or “selecting” encompasses a wide variety of actions and, therefore, “selecting” can include calculating, computing, processing, deriving, estimating, investigating, looking up (such as via looking up in a table, a database, or another data structure), inferring, ascertaining, or measuring, among other possibilities. Also, “selecting” can include receiving (such as receiving information), accessing (such as accessing data stored in memory) or transmitting (such as transmitting information), among other possibilities. Additionally, “selecting” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub-combination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A method for wireless communications, comprising:
receiving, by a Service Management and Orchestration (SMO) framework from a first entity, a first request relating to use of an external application;
transmitting, by the SMO framework to a second entity, a second request relating to performance of the external application;
receiving, by the SMO framework from the second entity, an indication of a result corresponding to the second request transmitted to the second entity; and
transmitting an instruction for wireless communication based on the indication.

2. The method of claim 1, further comprising:
configuring a data path between a third entity and the second entity based on the second request for input data to be transmitted by the third entity to the second entity; and
transmitting the data path to the third entity, the indication of the result being in response to the input data from the third entity.

3. The method of claim 1, wherein the second request is transmitted by routing the first request or mapping the first request to the second request to cause the second entity to receive.

4. The method of claim 1, wherein the external application comprises an artificial intelligence or machine learning (AI/ML) model, and
wherein the method further comprises:
transmitting a third request to deploy the AI/ML model to the second entity; and
in response to the third request, receiving endpoint information for accessing the deployed AI/ML model.

5. The method of claim 4, wherein the second request comprises inference input data for the AI/ML model, and
wherein the method further comprises:
determining the inference input data based on data collected from the wireless communications; and
determining an output data type for the indication of the result of the AI/ML model.

6. The method of claim 5, further comprising:
determining at least one measurement of the wireless communications or the AI/ML model;
a training request of the AI/ML model or a new model based on the at least one measurement; and
the training request of the AI/ML model or the new model to the second entity.

7. The method of claim 1, wherein the SMO framework is configured to operate on a radio access network domain only, a core network domain only, or both of the radio access network domain and the core network domain.

8. The method of claim 1, wherein the SMO framework is configured to operate on a specific function or a scope of the wireless communications.

9. The method of claim 1, further comprising:
registering the external application,
wherein registering the external application comprises:
retrieving information associated with the external application in a memory to register the external application, or
receiving the information associated with the external application from the second entity to register the external application.

10. The method of claim 9, further comprising: identifying the external application using a discovery operation in the SMO framework.

11. The method of claim 1, wherein the SMO framework comprises a non-real time intelligent controller (Non-RT RIC) and near-real time intelligent controller (Near-RT RIC) to support different time scale operations.

12. An apparatus for wireless communications, the apparatus configured to operate as a Service Management and Orchestration (SMO) framework, the apparatus comprising: at least one processor to configure the SMO framework to perform operations comprising:
receiving, by the SMO framework from a first entity, a first request relating to use of an external application;
transmitting, by the SMO framework to a second entity, a second request relating to performance of the external application;
receiving, by the SMO framework from the second entity, an indication of a result corresponding to the second request transmitted to the second entity; and
transmitting an instruction for wireless communication based on the indication.

13. The apparatus of claim 12, wherein the at least one processor configures the SMO framework to perform the operations further comprising:
configuring a data path between a third entity and the second entity based on the second request for input data to be transmitted by the third entity to the second entity; and
transmitting the data path to the third entity, the indication of the result being in response to the input data from the third entity.

14. The apparatus of claim 12, wherein the external application comprises an artificial intelligence or machine learning (AI/ML) model, and
wherein the at least one processor configures the SMO framework to perform the operations further comprising:
transmitting a third request to deploy the AI/ML model to the second entity; and
in response to the third request, receiving endpoint information for accessing the deployed AI/ML model.

15. The apparatus of claim 14, wherein the second request comprises inference input data for the AI/ML model, and
wherein the at least one processor configures the SMO framework to perform the operations further comprising:
determining the inference input data based on data collected from the wireless communications; and
determining an output data type for the indication of the result of the AI/ML model.

16. The apparatus of claim 15, wherein the at least one processor configures the SMO framework to perform the operations further comprising:
determining at least one measurement of the wireless communications or the AI/ML model;
a training request of the AI/ML model or a new model based on the at least one measurement; and
the training request of the AI/ML model or the new model to the second entity.

17. The apparatus of claim 12, wherein the at least one processor configures the SMO framework to perform the operations further comprising:
registering the external application, wherein registering the external application comprises:
retrieving information associated with the external application in a memory to register the external application, or
receiving the information associated with the external application from the second entity to register the external application.

18. A computer-readable storage medium for wireless communications that stores instructions for execution by one or more processors of a Service Management and Orchestration (SMO) framework, the instructions to configure the SMO framework to perform operations comprising:
receiving, by the SMO framework from a first entity, a first request relating to use of an external application;
transmitting, by the SMO framework to a second entity, a second request relating to performance of the external application;
receiving, by the SMO framework from the second entity, an indication of a result corresponding to the second request transmitted to the second entity; and
transmitting an instruction for wireless communication based on the indication.

19. The computer-readable storage medium of claim 18, wherein the external application comprises an artificial intelligence or machine learning (AI/ML) model, and
wherein the instructions configure the SMO framework to perform the operations further comprising:
transmitting a third request to deploy the AI/ML model to the second entity; and
in response to the third request, receiving endpoint information for accessing the deployed AI/ML model.

20. The computer-readable storage medium of claim 19, wherein the second request comprises inference input data for the AI/ML model, and
wherein the instructions configure the SMO framework to perform the operations further comprising:
determining the inference input data based on data collected from the wireless communications;
determining an output data type for the indication of the result of the AI/ML model determining at least one measurement of the wireless communications or the AI/ML model;
a training request of the AI/ML model or a new model based on the at least one measurement; and
the training request of the AI/ML model or the new model to the second entity.
